(19) United States
(12) Patent Application Publication
(10) Pub. No.: US 2002/0014912 A1
(43) Pub. Date: Feb. 7, 2002

(54) Internal reference voltage generating circuit, particularly of the CMOS type

(76) Inventors: Ettore Riccio, Vimodrone (IT); Laura Varisco, Cernusco Lombardone (IT)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/797,170

(22) Filed: Feb. 27, 2001

(30) Foreign Application Priority Data
Feb. 29, 2000 (IT) MI2000A000392

(51) Int. Cl. G05F 1/10

(52) U.S. Cl. 327/541

(57) ABSTRACT

An internal reference voltage generating circuit includes first and second MOS transistors connected in series with each other between first and second voltage references in a pull-up/pull-down configuration, and linked together at an output terminal of the generation circuit whereon a reference output voltage is presented. The generation circuit includes first and second feedback paths between the output node and the first and second transistors, respectively, to provide an output reference voltage value which lies within a range centering about an inversion value.

### TECHNICAL FIELD

This invention relates to an internal reference voltage generating circuit, particularly of the CMOS type.

Specifically, the invention relates to an internal reference voltage generating circuit of a type which comprises first and second MOS transistors connected in series with each other between first and second voltage references, in a pull-up/pull-down configuration, and linked together at an output terminal of the generation circuit, a reference output voltage being presented on said output terminal.

The invention relates, particularly but not exclusively, to a circuit produced with CMOS technology and, for convenience of illustration, the description which follows will deal with this field of application.

### BACKGROUND OF THE INVENTION

As is well known, reference voltage generating circuits are just circuits employed to bias specific internal circuit nodes to a reference voltage value which lies intermediate to a high-voltage reference VII and a low-voltage reference VL, e.g., a supply voltage Vdd and a ground GND in CMOS technology.

In particular, by so biasing internal circuit nodes, the nodes can be preloaded with their optimum values.

There exist many conventional circuits which can generate internal reference voltages but, as a rule, all such prior circuits are effective to generate a punctual voltage value, and adapted especially to drive low output impedances.

Furthermore, state-of-art circuits consume power even in static conditions.

### SUMMARY OF THE INVENTION

An embodiment of this invention provides a generation circuit, for generating an internal reference voltage, with such structural and functional features that overcome the limitations with which comparable prior devices have been beset.

In particular, the generation circuit is adapted to generate an internal reference voltage whose value lies within a range which extends from a high-voltage reference to a low-voltage reference and can be provided indefinitely small, it being contingent on manufacturing process tolerances only; the generating circuit also has null power consumption in static conditions.

The generation circuit uses a dual feedback path to limit the voltage value at an output node of the internal reference voltage generating circuit.

The generating circuit comprises first and second MOS transistors connected in series with each other between a first and a second voltage reference in a pull-up/pull-down configuration, and linked together at an output terminal of the generation circuit whereon a reference output voltage (Vout) is presented, and comprises at least first and second feedback paths between the output node and the first and second transistors, respectively, to provide an output reference voltage value which lies within a range centering about an inversion value.

In particular, the first and second feedback paths include each first and second inverters which are connected between the output node and a control terminal of the first and the second transistor, respectively, so as to turn these transistors on and off according to the value of the output reference voltage at the output node, the inverters being also effective to set the inversion value.

The features and advantages of an internal reference voltage generating circuit according to the invention will be apparent from the following description of an embodiment thereof, given by way of example and not of limitation with reference to the accompanying drawings.

### BRIEF DESCRIPTION OF THE DRAWINGS

In the drawings:

FIG. 1 shows an internal reference voltage generating circuit which embodies this invention; and

FIGS. 2 and 3 are detail views of the circuit shown in FIG. 1.

FIG. 4 is a circuit diagram of the inverters of the voltage generating circuit shown in FIG. 1.

### DETAILED DESCRIPTION OF THE INVENTION

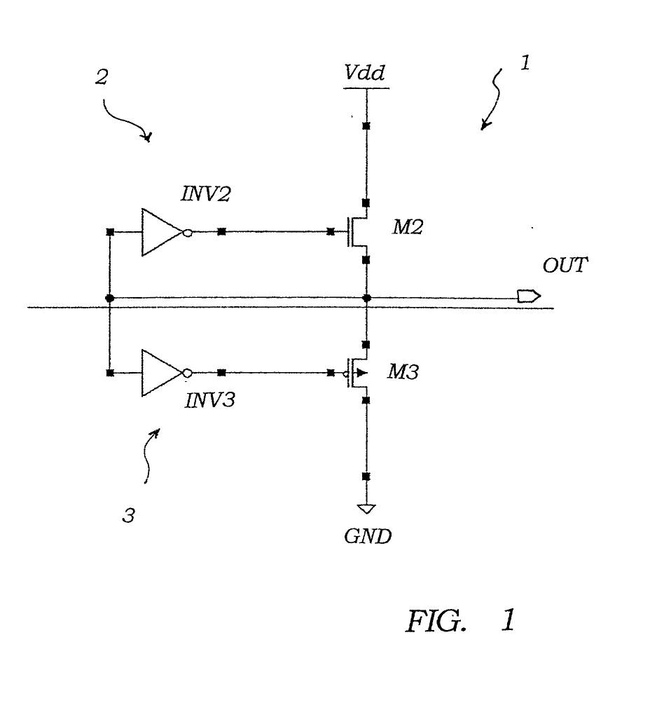

With reference to the drawings, in particular to FIG. 1 thereof, an internal reference voltage generating circuit according to an embodiment of the invention is shown generally at 1 in schematic form.

The generation circuit 1 comprises first 2 and second 3 sections, connected in series with each other between a high-voltage reference, specifically a supply voltage Vdd, and a low-voltage reference, specifically a ground GND, said first and second sections, 2 and 3, being linked together at an output terminal OUT of the generation circuit 1, on which terminal an output voltage Vout is presented,

The first section 2 comprises a MOS transistor M2 connected between the supply voltage reference Vdd and the output terminal OUT, and comprises an inverter INV2 connected between the gate terminal of the transistor M2 and the output terminal OUT.

The second section 3 similarly comprises a MOS transistor M3, connected between the output terminal OUT and the ground GND, and an inverter INV3 connected between the gate terminal of the transistor M3 and the output terminal OUT.

It should be noted that the generation circuit 1 provides a dual feedback at the output terminal OUT, using circuit elements of low complexity; in particular, the first section 2 of the generation circuit 1 provides a first feedback to check for and set variations of the output voltage Vout with respect to the supply voltage Vdd, and the second section 3 of the generation circuit 1 provides a second feedback to set the output node OUT with respect to deviations of the ground GND from a balance value.

Advantageously, the inverters INV2 and INV3 will turn on/off the transistors M2 and M3, which are an n-channel pull-up transistor and a p-channel pull-down transistor, respectively. In particular, the transistor M2 is turned off (on) when the voltage Vout at the output node OUT rises above (drops below) a predetermined value VEE set by the inverter INV2. Similarly, the transistor M3 is turned on (off) when the voltage Vout at the output note OUT rises above (drops below) a predetermined value VEE set by the inverter INV3.

To make the operation of the generation circuit 1 more clearly understood, the operation of the first and second sections 2 and 3 will now be described in greater detail.

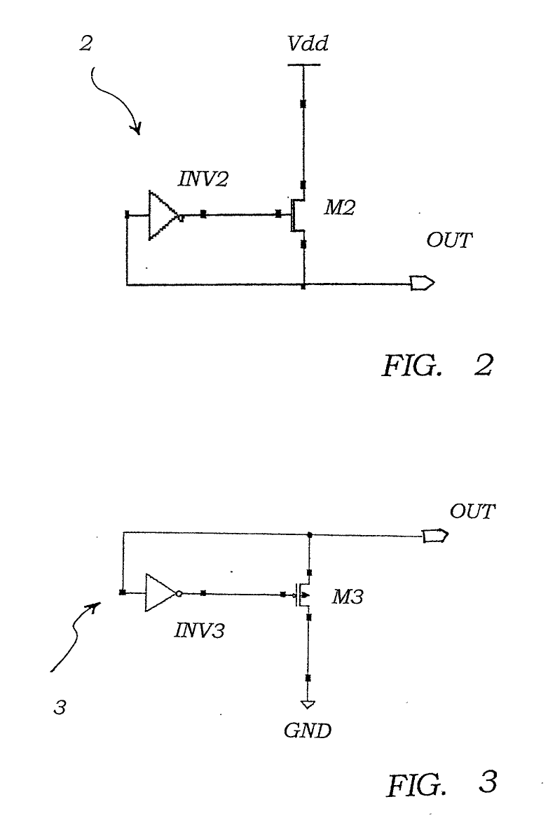

Referring to FIG. 2, the inverter INV2 of the first section 2 is selected to have a point of inversion at a first threshold value VEE−∈, where VEE is the value of the reference voltage of the inverters, and ∈ is an arbitrarily small value dependent on process tolerances used in fabricating the generation circuit 1.

When the output voltage Vout is higher than or equal to the first threshold value VEE−∈, the output of the inverter INV2 is pulled to ground GND, and the transistor M2 is turned off. In this condition, the output node OUT will be floating.

The output node OUT stays floating even as the value of its voltage Vout rises toward the value of the supply voltage Vdd; no control is exerted on the node OUT by the first section 2 while the output voltage Vout swings between VEE−∈ and Vdd.

Conversely, as the voltage Vout at the output node OUT drops with respect to the first threshold value VEE−∈, the output of the inverter INV2 is pulled to Vdd, because of its input becoming smaller than its point of inversion, and the transistor M2 is turned on. In this way, the transistor M2 causes the value of the output voltage Vout to rise back to the first threshold value VEE−∈, whereupon the output of the inverter INV2 goes back to GND and the transistor M2 is turned off.

Referring to FIG. 3, the inverter INV3 of the second section 3 is selected to have a point of inversion at a second threshold value VEE+∈.

When the output voltage Vout is lower than or equal to the second threshold value VEE+∈, the output of the inverter INV3 is pulled toward the supply voltage Vdd, and the transistor M3 is turned off. In this condition, the output node OUT will be floating.

The output node OUT stays floating even as the value of its voltage Vout decreases toward the ground GND; no control is exerted on the node OUT by the second section 3 while the output voltage Vout swings between VEE+∈ and GND.

Conversely, as the voltage Vout at the output node OUT rises with respect to the second threshold value VEE+∈, the output of the inverter INV3 is pulled to GND, because of its input becoming greater than its point of inversion, and the transistor M3 is turned on. In this way, the transistor M3 causes the value of the output voltage Vout to drop back to the second threshold value VEE+∈, whereupon the output of the inverter INV3 goes back to Vdd and the transistor M3 is turned off.

Thus, the generation circuit 1, comprised of said first 2 and second 3 sections, will present on its output terminal OUT a voltage value Vout that swings within the following range:

VEE−∈≦Vout≦VEE+∈ (1)

by virtue of the combined feedback action of the sections 2 and 3.

When the output voltage Vout lies within the range (1) above, no short circuits occur between the supply voltage reference Vout and the ground reference GND. Hereinafter, the value VEE will be referred to as the point of inversion of the generation circuit 1.

Advantageously, the generation circuit 1 will supply an output voltage Vout which is held within a predetermined range about the point VEE of inversion, utilizing a dual feedback which acts on the output terminal OUT.

In addition, this output voltage range can be changed, within the range of values from GND to Vdd, by modifying the working conditions of the elements which comprise the circuit 1, in particular by shifting the point VEE of inversion.

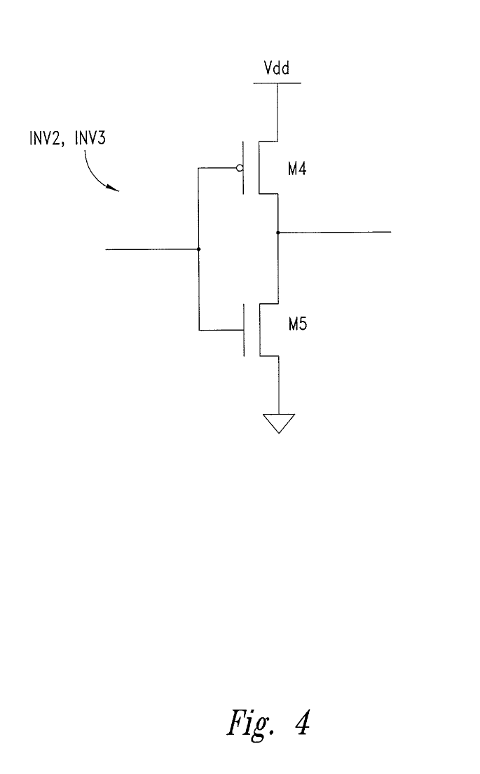

An embodiment of the inverters INV2, INV3 is shown in FIG. 4. Each inverter INV2, INV3 includes a PMOS pull-up transistor M4 connected between the supply voltage Vdd and an inverter output node 4 and an NMOS pull-down transistor M5 connected between the inverter output node 5 and GND. Using a pull-up/pull-down configuration for the transistors M4, M5 in the inverters INV2 and INV3 secures the ability to shift the point of inversion of the generation circuit 1 by acting on the transistor size.

In particular, a change in the size of the pull-up and pull-down transistors M4, M5 inside the inverters INV2 and INV3 will have as its chief effect a variation in the equivalent resistance of the transistors in their conductive state. Typically, the pull-up and pull-down transistors are adjusted in size to equalize the load current capacities of the source and sink regions of the transistors.

Using the same principle, the drive capacity of the pull-up transistor can be unbalanced with respect to the pull-down transistor inside the inverters INV2 and INV3, thus shifting the value of the point of inversion within the range set by the voltage references used.

In particular, the point of inversion of the generation circuit 1 obeys the following relation:

I(pull-down)=I(pull-up) (2)

where:

I(pull-down) is the value of the current that is flowing through the pull-down transistor inside the inverters INV2 and INV3, and

I(pull-up) is the value of the current that is flowing through the pull-up transistor inside the inverters INV2 and INV3, that is:

$$\begin{matrix}\begin{matrix}\frac{1}{2} \cdot {μ}_{n} \cdot {C}_{OX} \cdot \frac{{W}_{n}}{{L}_{n}} \cdot {( {V}_{GS} - {V}_{THN} )}^{2} = \frac{1}{2} \cdot {μ}_{p} \cdot {C}_{OX} \cdot \frac{{W}_{p}}{{L}_{p}} \cdot \\ {( {V}_{GS} - {V}_{THP} )}^{2}\end{matrix} \\ i . e . : & ( 3 ) \\ {μ}_{n} \cdot \frac{{W}_{n}}{{L}_{n}} \cdot {( {V}_{IN} - {V}_{THN} )}^{2} = {u}_{p} \cdot \frac{{W}_{p}}{{L}_{p}} \cdot {( {V}_{IN} - Vdd - {V}_{THP} )}^{2} & ( 4 )\end{matrix}$$

where:

μₙ, μₚ are the transconductance parameters of the n-channel and p-channel transistors, the transconductance of an n-channel transistor being usually twice or thrice that of a p-channel transistor;

V_{THN}, V_{THP} are the threshold voltage values of the n-channel and p-channel transistors; and

VIN is the value to be measured, equal to the value of the point VEE of inversion.

It should be noted that the transconductance parameters and the threshold voltages are physical values, and that the size of the transistors used can be adjusted at the designing stage. Therefore, once the input voltage value VIN=VEE is defined, the relation between the dimensional values of the transistors, in particular their W/L ratios, is expressed by equation (4) above.

Finally, it should be mentioned that all the parameters which appear in equation (4), barring the input voltage and the supply voltages, are dependent on the process used to fabricate the generation circuit 1. The better the technological process applied, the smaller the value of factor 6 in equation (1).

To summarize, the generation circuit 1 provides a reference voltage value Vout contained in a range which centers about a point VEE of inversion, this point being chosen arbitrarily within the range of supply voltages used, and does achieve this without static power consumption and using components of trivial complexity.

One possible application of the generation circuit 1 has relation to the circuitry of sense amplifiers in a memory device. In fact, a sense amplifier for a memory device is nothing but a device which reads a voltage difference between two signals, which difference is tied to the information contained in a specific memory cell.

In all cases, if the input terminals of two sense amplifiers are preloaded to a value equal to one half the supply voltage (Vdd/2), the dynamic range of the sense amplifier can be improved, and output switchings made faster and free of glitches. Thus, by associating two generation circuits according to the invention with the input terminals of the sense amplifiers to correctly preload them, the performance of the sense amplifiers, as well as the overall performance of the memory device, can be optimized.

Such improvements would be specially useful with OTP (One Time Programmable) memories.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An internal reference voltage generating circuitcomprising:
first and second MOS transistors connected in series with each other between first and second voltage references in a pull-up/pull-down configuration, and linked together at an output terminal of the generation circuit whereon a reference output voltage is presented; and
first and second feedback paths between said output node and said first and second transistors, respectively, to maintain the output reference voltage within a range centering about an inversion value.

2. An internal reference voltage generating circuit according to claim 1, wherein said first feedback path includes a first inverter connected between the output node and a control terminal of said first MOS transistor and said second feedback path includes a second inverter connected between the node and a control terminal of said second MOS transistor, so that said transistors will be turned on/off according to the output reference voltage at the output node.

3. An internal reference voltage generating circuit according to claim 2, wherein said inversion value is set by said first and second inverters.

4. An internal reference voltage generating circuit according to claim 3, wherein said first inverter has a point of inversion at a first threshold value equal to a difference between the inversion value of the generating circuit and a tolerance factor dependent on tolerances of a process of fabricating the generating circuit.

5. An internal reference voltage generating circuit according to claim 3, wherein said second inverter has a point of inversion at a second threshold value equal to a sum of the inversion value of the generating circuit and a tolerance factor dependent on tolerances of a process of fabricating the circuit.

6. An internal reference voltage generating circuit according to claim 1, wherein said first feedback path operates, when the output reference voltage is below said range, to restore the output reference voltage to said range, and said second feedback path operates, when the output reference voltage is above said range, to restore the output reference voltage to said range.
